(19) United States
(12) Patent Application Publication
(10) Pub. No.: US 2014/0201192 A1
(43) Pub. Date: Jul. 17, 2014

(54) AUTOMATIC DATA INDEX ESTABLISHMENT METHOD

(71) Applicant: SYSCOM COMPUTER ENGINEERING CO., TAIPEI CITY (TW)

(72) Inventors: PEI-FEN HU, TAIPEI CITY (TW); CHEN-YU YEN, TAIPEI CITY (TW); SHU-YUAN HU, TAIPEI CITY (TW); KUN-TING CHIU, TAIPEI CITY (TW)

(73) Assignee: SYSCOM COMPUTER ENGINEERING CO., TAIPEI CITY (TW)

(21) Appl. No.: 13/741,400

(22) Filed: Jan. 15, 2013

(51) Int. Cl. G06F 17/30

(52) U.S. Cl. CPC G06F 17/30336
USPC 707/722

(57) ABSTRACT

An automatic data index establishment method includes the steps of comparing a data index existed in at least one table when a database inquires at least one query to obtain the data index correspondingly and directly uses the data index to search related data. If the query has no corresponding data index, a Where Condition field, a Sorting field and a Group By field of the query are recorded and integrated to automatically generate the newly established data index and fill the data index into the table correspondingly. Therefore, the database has intelligent functions with automatic analysis to automatically generate, update, and delete the data index, so as to achieve the effects of enhancing the accuracy and execution efficiency of the data management and reducing the manpower of data managers effectively.

### BACKGROUND OF THE INVENTION

1. Field of the Invention

The present invention relates to the technical field of database management, and more particularly to an automatic data index establishment method for enhancing the accuracy of index establishment and database execution performance and reducing the manpower of database managers.

2. Description of the Related Art

Besides the functions of storing data and establishing index fields, a database system also requires the function of allowing a database manager to insert, update, delete and retrieve data in a database. To facilitate the operation and use, most conventional database systems support a Structured Query Language (SQL) and allow data managers to input data and establish tables through an external database client application. In the meantime, the data managers can define at least one data index according to the inquiry condition of each data field for expediting an operation such as the inquiry of data or the retrieval of contents. However, the data managers may define a wrong condition in the aforementioned data index establishment method due to the personal experience of data managers and causes the wrong data inquiry, and thus requiring defining the conditions again. In a practical operation and a process of updating programs or data, it is often necessary to insert an additional index, so that the association of each record of data with its respective data index becomes a complicated and difficult management operation. In addition, if it is necessary to search all indexes with a certain condition for retrieving data with a specific attribute, the aforementioned database client application generally produces a large quantity of duplicated data, so that most of the memories are occupied to reduce the database execution performance.

To overcome the foregoing problems, improved methods and various external database client applications as R.O.C. Pat. No. 508511, 1231433 and 1269985 were disclosed to achieve the effects of minimizing the instruction error percentage produced with the external programs during a process of updating the system or changing the data for different types of databases, simplifying the management process, and improving the system execution performance. However, the conventional methods still have a data structure with an external program, so that the stability of the operation may be affected by the compatibility issue of program codes between the database and the external program. When instructions of an external program are changed, the corresponding source codes must be converted and re-compiled before the database can be used, so that the conventional methods consume much time and cost and are inconvenient for use. Even if the conventional methods come with a built-in automatic indexing database structure, the functions for automatically generating an index for a field corresponding to the inquiry conditions fail to analyze and integrate the whole set of data, and thus too many indexes are stored to result in a poor execution performance and occupy much memory space which are unfavorable to data management.

In view of the aforementioned problems, it is a main subject for related manufactures to develop a database system with built-in intelligent functions of automatically establishing, updating and deleting data indexes to expedite the efficiency and accuracy of a data search and reduce the manpower of data managers.

### SUMMARY OF THE INVENTION

In view of the problems of the prior art, it is a primary objective of the present invention to overcome the problems by providing an automatic data index establishment method having the built-in intelligent functions of automatically establishing, updating and deleting data indexes to enhance the accuracy and execution efficiency of data management and reduce the manpower of data managers.

To achieve the aforementioned objective, the present invention provides an automatic data index establishment method that relates to the technology of automatically generating at least one data index when a database executes related data of at least one query, so as to expedite the inquiry of the related data and improve the execution performance. The method comprises the steps of: receiving the query; comparing the data index existed in at least one table; using the data index existed in the table to search related data of the corresponding query directly, when the query obtains the corresponding data index; recording a Where Condition field, a Sorting field and a Group By field of the query, when the query has no corresponding data index; and integrating the Where Condition field, the Sorting field and the Group By field to automatically generate a newly established data index, and filling the newly established data index into the corresponding table.

Wherein, the data index with the Where Condition field, the Sorting field and the Group By field is compared to generate a newly established data index when the Where

Condition field, the Sorting field and the Group By field are integrated.

An inquiry time of the query is recorded, and the table and an identification code (ID) of the data index are recorded when the existed index data are used for searching the query.

After the newly established data index is generated, the inquiry time and the identification code are computed to obtain an idle time of the data index, and the idle time is compared with a parameter value, and the corresponding data index is deleted if the idle time is greater than the parameter value. In addition, the database periodically analyzes the table to delete the data index. Therefore, any data index not used for a long time will be dropped to avoid saving too many unnecessary data indexes or becoming a burden to the database execution performance.

In this preferred embodiment, the database is a cloud database and supports a structured query language (SQL), so that the method of the present invention can be applied extensively for different database structures to enhance the practicality of the database.

In summation, the present invention provides a built-in automatic index management procedure of a database with intelligent functions to allow the database to automatically analyze the query and automatically establish, update and delete the data index, so that no external program is required to lower the data management cost and avoid the compatibility issue of programs to improve the stability of the operation. In addition, when the method is applied in a conventional database structure, the manpower of data managers can be reduced and the accuracy of establishing the data index can be enhanced.

### BRIEF DESCRIPTION OF THE DRAWINGS

FIG. 1 is a flow chart of a preferred embodiment of the present invention;

FIG. 2 is a block diagram of a database of a preferred embodiment of the present invention;

FIG. 3 is a schematic view of a database operating interface of a preferred embodiment of the present invention;

FIG. 4 is a schematic view of a field record of a preferred embodiment of the present invention;

FIG. 5 is another flow chart of a preferred embodiment of the present invention; and

FIG. 6 is another database block diagram of a preferred embodiment of the present invention.

### DETAILED DESCRIPTION OF THE PREFERRED EMBODIMENTS

The technical content of the present invention will become apparent with the detailed description of preferred embodiments and the illustration of related drawings as follows.

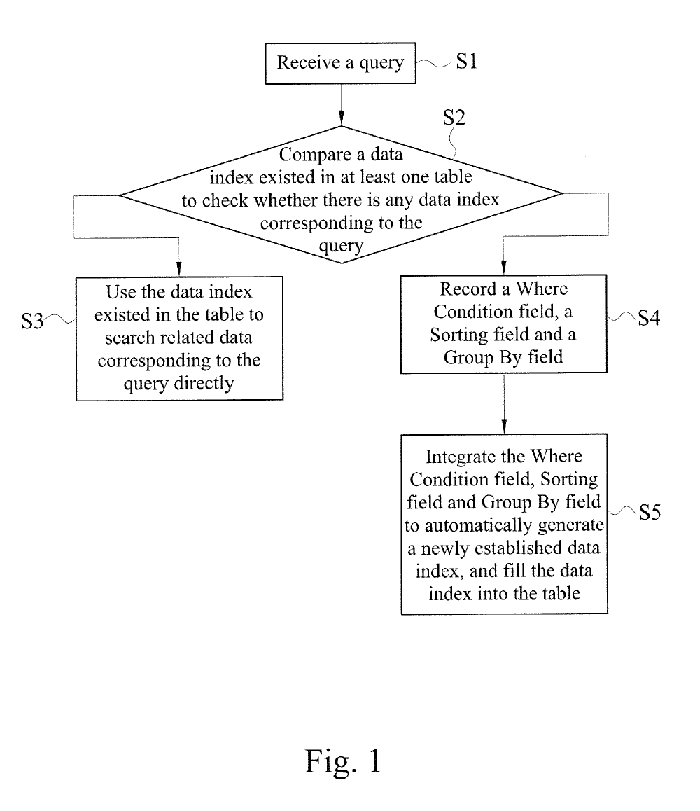

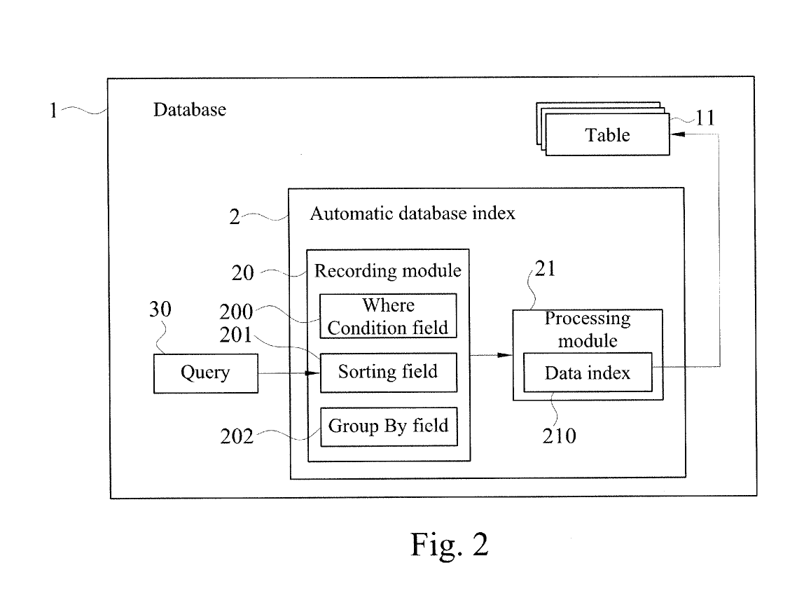

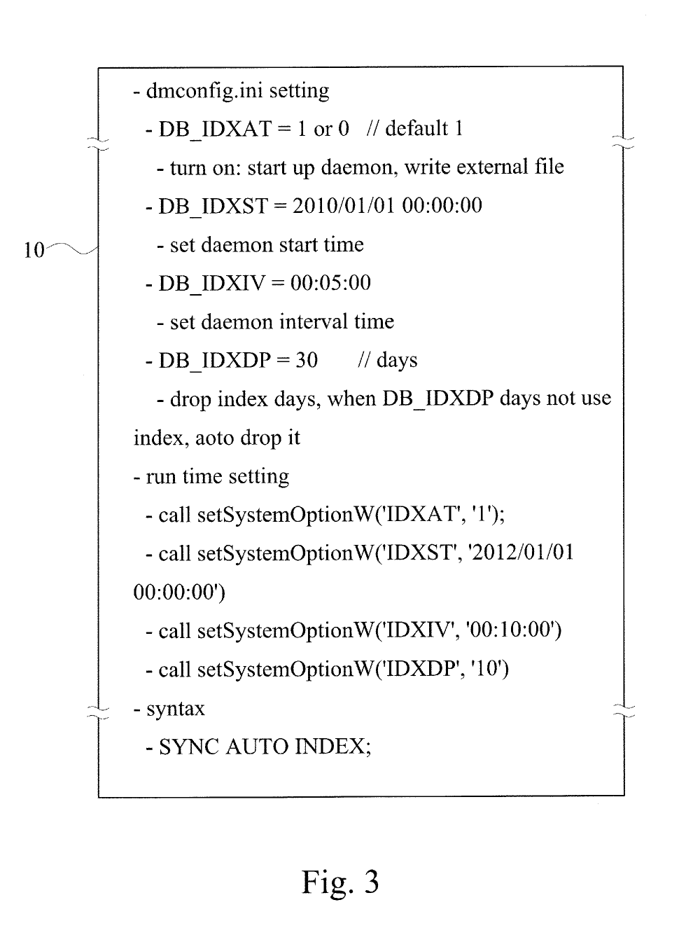

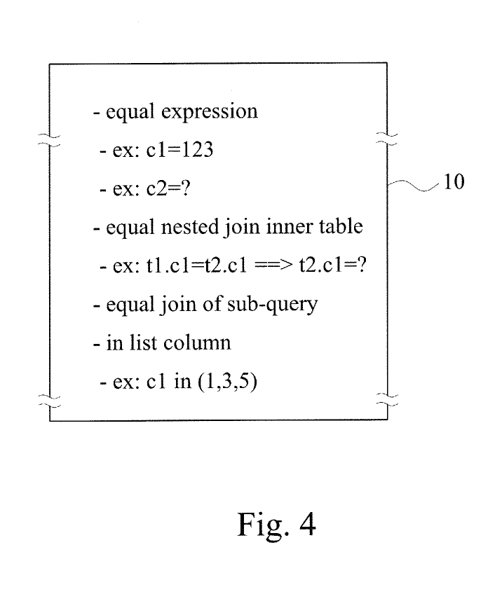

With reference to FIGS. 1 to 4 for a flow chart, a block diagram of a database, a schematic view of a database operating interface and a field record of a preferred embodiment of the present invention respectively, the database 1 has a built-in intelligent function with an automatic data index establishment procedure 2 for automatically searching at least one query 30 received by the database 1 and automatically integrating and analyzing a query field to automatically establish, update or delete at least one data index 210 of a corresponding field condition, so as to achieve the effects of managing the data index 210 effectively, expediting the inquiry of related data and improving the execution performance. The automatic data index establishment procedure 2 comprises a recording module 20 and a processing module 21, and an automatic data index establishment method comprises the following steps. The recording module 20 can be a receiving procedure of the database 1 or an electrically coupled to the database 1 for searching and recording all of the queries 30 inputted, and the processing module 21 can be a daemon and electrically coupled to the recording module 20, such that when the database 1 is started up to set time or issue an instruction, the data searched by the recording module 20 are analyzed and integrated to establish an appropriate data index 210.

Firstly, the database 1 is opened to enter into an operating interface 10, and the automatic data index establishment procedure 2 of the daemon is started at the same time.

Step S1: When the database 1 receives the query 30 and examines related data, the recording module 20 searches the query 30 received by the database 1 such as “Select* from t1 where c1=c12, select* from t1 order by c2, c1 or select* from t1 order by c2”.

It is noteworthy to point out that the automatic data index establishment procedure 2 is a built-in procedure, so that its source codes are the same as the source codes used by the database 1, and there is no compatibility or abnormality issue caused by the code conversion or recompilation. Step S2: The database 1 compares the data index 210 existed in at least one table 11 to confirm whether there is the data index 210 corresponding to the query 30.

Step S3: When the query 30 obtains the corresponding data index 210, the data index 210 existed in the table 11 are used to search related data corresponding to the query 30 directly. Step S4: When the query 30 has no corresponding data index 210, a Where

Condition field 200, a Sorting field 201 and a Group By field 202 of the query 30 are recorded. Now, a data manager can check the operation procedure of the recording module 20 through the operating interface 10. For example, if the query 30 is “Select* from t1 where c1=c12” or “select* from t1 where c1=c12 and c3=“hello”, the content of the Where Condition field: 200 c1 and c1, c3 can be recorded; if the query 30 is “Select* from t1 order by c2, c1”, the Sorting field 201: c2, c1 can be recorded; or the query 30 is “Select* from t1 order by c2”, the Group By field 202: c2 can be recorded.

Step S5: The processing module 21 receives the recorded contents of the Where Condition field 200, the Sorting field 201 and the Group By field 202 from the recording module 20 and integrates these fields to automatically generate a newly established data index 210. For example, if the query 30 is “Select* from t1 where c1=c12” and search and record c1, the data index 210 Of “establish index idx1 on t1 (c1)” is established accordingly and filled into the corresponding table 11 to facilitate the data management and retrieval. When this method is applied to a conventional database structure, the automatic data index establishment procedure 2 automatically searches the used query 30, and analyzes the fields for the query 30 without the data index, and then the data index 210 is established automatically, so as to achieve the effects of reduce the work load of the data managers and lowering the manpower cost.

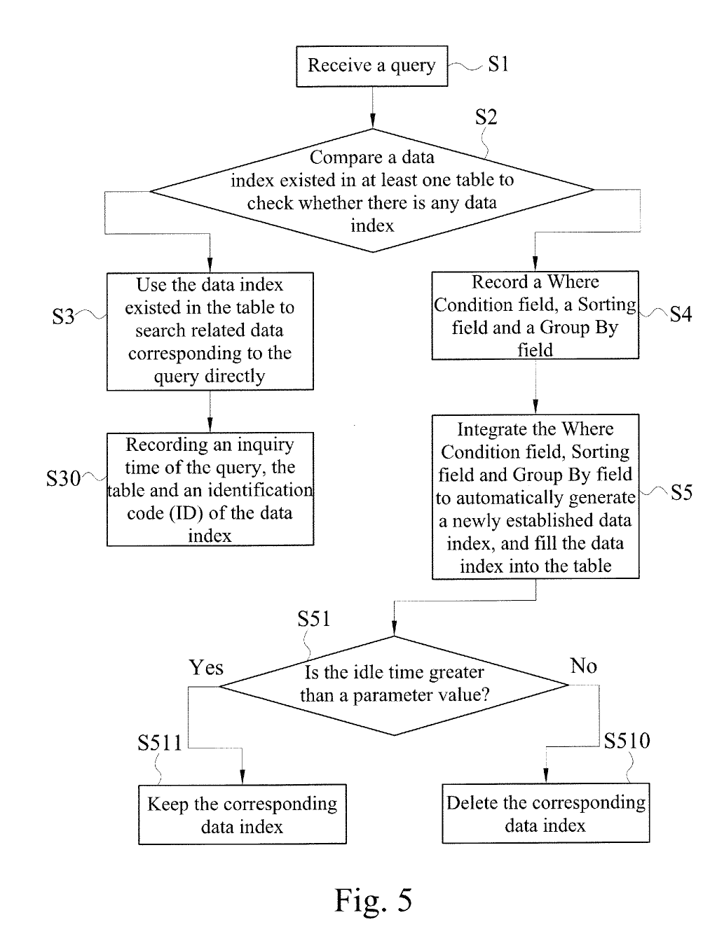

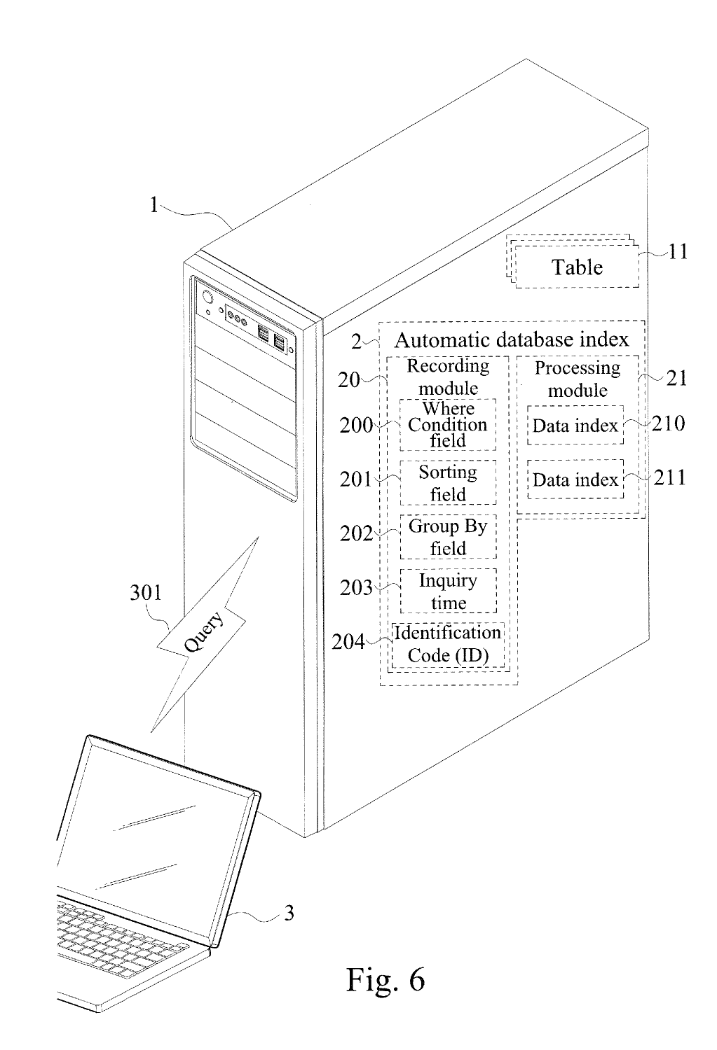

With reference to FIGS. 5 and 6 for another flow chart and another database of a preferred embodiment of the present invention respectively, the database 1 can be a cloud database provided for a data manager to access data through a remote device 3, or retrieve, update or delete the data stored in the database to automatically integrate the data applicable for global and cluster data index 210, so as to enhance the execution performance and facilitate the data manager to add cloud data servers and adjust the database structure. To avoid too many indexes existed in a single table 11 that may affect the execution performance of an operation such as adding, deleting or updating data. The processing module 21 in the step S5 compares the existing data index 210 with the recently searched Where Condition field 200, Sorting field 201 and Group By field 202, integrates and simplifies the recorded field of each query 30. For example, when the recording module 20 searches two queries 30: “Select* from t1 where c1=c12” and “select* from t1 where c1=c12 and c3=“hello” and records c1 and c1, c3, the processing module 21 establishes the data index 210: establish index idx13 on t1 (c1,c3) while satisfying the conditions of the two queries 30, so as to prevent establishing a new data index 210 for each field of each query 30. In other words, one single data index 210 can be used for different queries 30 to automatically reduce the quantity of index significantly and control the number of indexes to enhance the management performance effectively.

In addition, in the Step S3, after the existing data index 210 is used for searching the query, the recording module 20 carries out the following step.

Step S30: An inquiry time 203 of the query 30 executed by the database 1 is recorded, and the table 11 and an identification code (ID) 204 of the data index 210 used for executing the related data inquiry are recorded. Therefore, in the Step S5, after the processing module 21 generates the newly established data index 210, the following steps are executed.

Step S50: The inquiry time 203 and the identification code 204 are computed to obtain an idle time 211 of the data index 210.

Step S51: The idle time 211 is compared to check whether it is greater than a parameter value. If the idle time 211 is greater than the parameter value, the step S510 is executed.

Step S510: The corresponding data index 210 is deleted.

If the idle time is not greater than the parameter value, the step S511 is executed.

Step S511: The corresponding data index 210 is kept, wherein the database 1 periodically analyzes the table 11 and periodically deletes any data index 210 that is not used for a long time to enhance the practicality of establishing the data index 210.

It is noteworthy that the database 1 further supports SQL to facilitate applying the method in servers of different structures to enhance the practicality.

What is claimed is:

1. An automatic data index establishment method, being a method for automatically generating at least one data index when a database executes related data of at least one query to expedite an inquiry of the related data and improve the execution performance, comprising the steps of:
receiving the query;
comparing the data index existed in at least one table;
using the data index existed in the table to search related data corresponding to the query directly, when the query correspondingly obtains the data index;
recording a Where Condition field, a Sorting field and a Group By field of the query, when the query has no corresponding data index; and
integrating the Where Condition field, the Sorting field and the Group By field to automatically generate a newly established data index, and filling the newly established data index into the table correspondingly.

2. The automatic data index establishment method of claim 1, integrating the Where Condition field, the Sorting field and the Group By field is based comparing the data index with the Where Condition field, the Sorting field and the Group By field to generate the newly established data index.

3. The automatic data index establishment method of claim 2, further comprising the steps of: recording an inquiry time of the query; and recording the table and an identification code of the data index, in the step of using the data index to search the query.

4. The automatic data index establishment method of claim 3, further comprising the steps of: computing the inquiry time and the identification code to obtain an idle time of the data index; and comparing the idle time with a parameter value, and deleting the data index correspondingly if the idle time is greater than the parameter value, after the newly established data index is generated.

5. The automatic data index establishment method of claim 4, wherein the database periodically analyzes the table to delete the data index.

6. The automatic data index establishment method of claim 5, wherein the database is a cloud database.

7. The automatic data index establishment method of claim 6, wherein the database supports a Structured Query Language (SQL).
